(19) United States
(12) Patent Application Publication
(10) Pub. No.: US 2004/0250209 A1
(43) Pub. Date: Dec. 9, 2004

(54) Automated composition assistant

(76) Inventors: Gail Norcross, Winchendon, MA (US); Gloria Sweeney, Winchendon, MA (US)

Correspondence Address: KATHLEEN CHAPMAN, ESQ., 765 GREENVILLE RD., MASON, NH, 03048, US

(21) Appl. No.: 10/857,821

(22) Filed: Jun. 1, 2004

Related U.S. Application Data
(60) Provisional application No. 60/476,031, filed on Jun. 5, 2003.

(51) Int. Cl. G10H 7/00

(52) U.S. Cl. 715/700

(57) ABSTRACT

A system and method for educating writers in the preparation of a written work, including identifying a writing structure, any composition aids, and any composition style features for the composition, then instructing the user through the use of the writing structure, composition aids, and composition style features to guide the writer's entry of the composition. While the composition is being entered, and after the composition is completely entered, the system and method interactively check the composition with respect to writing structure, composition correction, and composition style features and allow the writer to modify the composition. The final product is a completed written work of virtually any style, subject, and length.

### CROSS REFERENCE TO RELATED APPLICATIONS

The present application claims priority to U.S. Provisional Application No. 60/476,031 filed Jun. 5, 2003, entitled AUTOMATED COMPOSITION ASSISTANT which is incorporated herein by reference.

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND OF THE INVENTION

The present invention relates generally to instruction in written composition and, more specifically, to an automated system and method for guiding the user through the steps of creating, reviewing, and correcting a coherent, organized, perhaps multilingual, written composition.

Providing instruction in preparing an organized composition has long been an elusive goal. Systems are disclosed in the prior art in which hand-held manipulatives are used to encourage proper sentence selection in the context of a composition topic, or user's thoughts are written to cards in a random order, and the cards are physically strung together in composition order. Systems exist that help teachers administer and score written compositions. Systems also exist that help a user write a paper based on an existing writing. These systems are focused on analyzing the existing writing for the user. There are systems that help a user to write a composition that is easily translatable into a foreign language by encouraging the use of disambiguated text.

Intelligent tutor technology, based on artificial intelligence, facilitates the development of basic writing process skills such as prewriting, drafting, revision and editing. Intelligent tutor technology makes use of a knowledge engine, which is usually a suite of complicated software that learns the attributes of the user as the user learns the subject matter. There are systems that encourage the user to write a composition according to a set of cookbook-type rules. There are also automated textbook systems that provide users with textbook-based instruction with an automated interface.

None of the present systems or methods provides integrated written composition instruction that is integrated with the preparing a completed written composition. Integrated written composition instruction can guide the user in written composition form, while at the same time producing a completed written composition for, for example, an effort that is unrelated to written composition pedagogy. None of the present systems provides an effective, customizable way to automatically guide a user through the process of writing an essay that conforms to a user-selected structure and teaches the user to review and correct the composition. None of the present systems provides this capability within the context of a conventional word processing system. And none provides guidance for various types of writings, for example, simple essays, business writings, academic theses, in terms of literary elements, definitions, and usage of elements.

An object of the present invention is therefore to provide a composition framework and instructional aids to automatically guide a user through the preparation of a written composition. The instructional aids can be concise tips or hints or directions.

Another object of the present invention is to provide, after use of the present invention, a completed composition.

Yet another object of the present invention is to provide an automated toolbar that encompasses step-by-step tools to assist the user in writing a composition.

Yet another object of the present invention is to provide a figurative language pull-down from the toolbar that provides categories of relevant language rules.

Yet still another object of the present invention is to allow the composition framework and instructional aids to vary according to the type of composition and the skill level of the user.

A further object of the present invention is to provide a system that can take full advantage of the capabilities inherent in a conventional word processor, and can operate within the context of such a conventional word processor.

A further object of the present invention is to provide user-selected and pre-stored composition style features to allow interactive refinement of the composition to make the composition, for example, more readable, grammatically correct, homophonically correct, and having appropriate sentence variety.

A still further object of the present invention is to provide language translation of the composition into a user-selected preferred language.

A yet still further object of the present invention is to provide audio review of the composition, so that the user can hear how the completed composition sounds, both in the original language and in the user-selected preferred language.

A yet still further object of the present invention is to provide a system and method to structure each paragraph according to modifiable rules.

A yet still further object of the present invention is to provide typical essay topics having modifiable focus questions positioned within the essay to prompt the user, and positioned within the essay for easy removal when the essay is complete.

### SUMMARY OF THE INVENTION

The objects set forth above as well as further and other objects are provided by the system and method of the present invention. These objects and other advantages are achieved by the illustrative embodiment of the invention described hereinbelow.

The present invention simplifies the writing process and helps a user to organize ideas by providing a series of automated steps that replaces steps provided in, for example, a text book. The user can begin using the present invention at virtually any skill level since the present invention allows for the varying skill levels to act as building blocks for each other. As a result, the user gradually improves in the areas of beginning and completing compositions and organizing ideas. Through repeated use of the present invention the user gains confidence in expressing ideas and becomes an effective writer.

In the environment of the present invention, the user is allowed to choose from a set of possible writing structures which can be user- or system-supplied. The present invention enables enforcement of the chosen writing structure or framework by prompting the user to prepare parts of the composition according to the chosen structure. While the user is preparing the composition, the present invention provides automated guidance and automated user- or system-supplied aids that can be geared to, for example, but not limited to, the level or age of the user, and that can be geared to, for example, but not limited to, the subject matter, writing structure, and composition style. The present invention also provides for language translation. Finally, the present invention provides for audio review of the composition in either the original language or the language after translation.

The method of the present invention includes the step of identifying a writing structure that has an associated set of composition parts and correction features. The method can further include the step of receiving a composition, typically in parts, and instructing the user to check the composition part while the composition is in progress according to the selected writing structure and correction features. The system checks the user's modifications and, if correct, updates the composition according to the user's modifications. At the same time, the system can provide instructional tips and aids to assist the user not only in completing the composition, but also in learning how to structure and complete future compositions. Composition correction features can include homophone identification, sentence variation, verb tense, and composition voice. The method could optionally include the step of providing an audio review of the composition. The method could also optionally include the steps of receiving a preferred language, translating the composition into the preferred language, and providing an audio review of the translated composition.

The system of the present invention for educating writers can include a writing structure subsystem capable of receiving at least one writing structure, the writing structure subsystem being capable of receiving a composition, the writing structure subsystem interactively enforcing the at least one writing structure while the composition is being received. The system can further include a composition aids subsystem capable of interactively providing at least one composition aid while the composition is being received, reviewed, and modified. The system can still further include a composition correction/instruction subsystem capable of interactively receiving at least one modification to the composition. Optionally, the composition aids subsystem can provide an audio review of the composition. The system can optionally include a translation subsystem capable of translating the composition into a preferred language, and the composition aids subsystem can provide an audio review of the composition in the preferred language. The writing structure can include, but is not limited to, creative essays, factual essays, academic theses, and historical essays. The system can include writing structures such as, but not limited to, skill-appropriate structures, age-appropriate structures, and language ability-appropriate structures. A system modification subsystem of the present invention can relate the system- or user-supplied writing structures to system- or user-supplied composition aids so that the user sees composition aids that are appropriate for a particular structure. The composition correction features can include, but aren't limited to, homophone identification, sentence variation, verb tense, and composition voice.

The system and method of the present invention can produce a written composition that results from the user's selections from a toolbar that can be made available in the context of a conventional word processor. The toolbar allows selections that can guide the user through composition construction, from the overall writing structure through, for example, but not limited to, details of style, homophones, sentence structure, sentence variety, and essay content.

The method of the present invention can be, in whole or in part, implemented electronically. Signals representing actions taken by elements of the system can travel over electronic communications media. Control and data information can be electronically executed and stored on computer-readable media. The system can be implemented to execute on a node in a computer network. Common forms of computer-readable media include, for example, a floppy disks, flexible disks, hard disks, magnetic tapes, or any other magnetic media, CDROMs or any other optical media, punched cards, paper tape, or any other physical media with patterns of holes, RAMs, PROMs, EPROMs, FLASH-EPROMs, or any other memory chip or cartridge, carrier waves, smart cards, compact flash cards, flash memory, or any other media from which a computer can read.

For a better understanding of the present invention, reference is made to the accompanying drawings and detailed description. The scope of the present invention is pointed out in the appended claims.

### BRIEF DESCRIPTION OF THE SEVERAL VIEWS OF THE DRAWING

FIG. 1 is a schematic block diagram of the computer environment of the illustrative embodiment of the present invention;

FIG. 2 is a schematic block diagram of basic components of the illustrative embodiment of the system of the present invention;

FIG. 3 is a schematic block diagram of optional components of the illustrative embodiment of the system of the present invention;

FIG. 4 is a flowchart of the method of the present invention;

FIG. 5 is a screen image showing an exemplary top-level toolbar of the illustrative embodiment of the present invention;

FIG. 6 is a screen image showing an exemplary list of topics and a topic selection mechanism that could be presented to a user of the illustrative embodiment of the present invention;

FIG. 7 is a screen image showing an exemplary writing structure of the illustrative embodiment of the present invention;

FIG. 8 is a screen image showing an exemplary choice of a composition part of the illustrative embodiment of the present invention; and

FIG. 9 is a screen image showing an exemplary list of transitional words of the illustrative embodiment of the present invention.

### DETAILED DESCRIPTION OF THE INVENTION

The present invention is a system and method for automated composition instruction and preparation. All examples provided herein are illustrative of aspects of the invention and not for limiting the uses of the system.

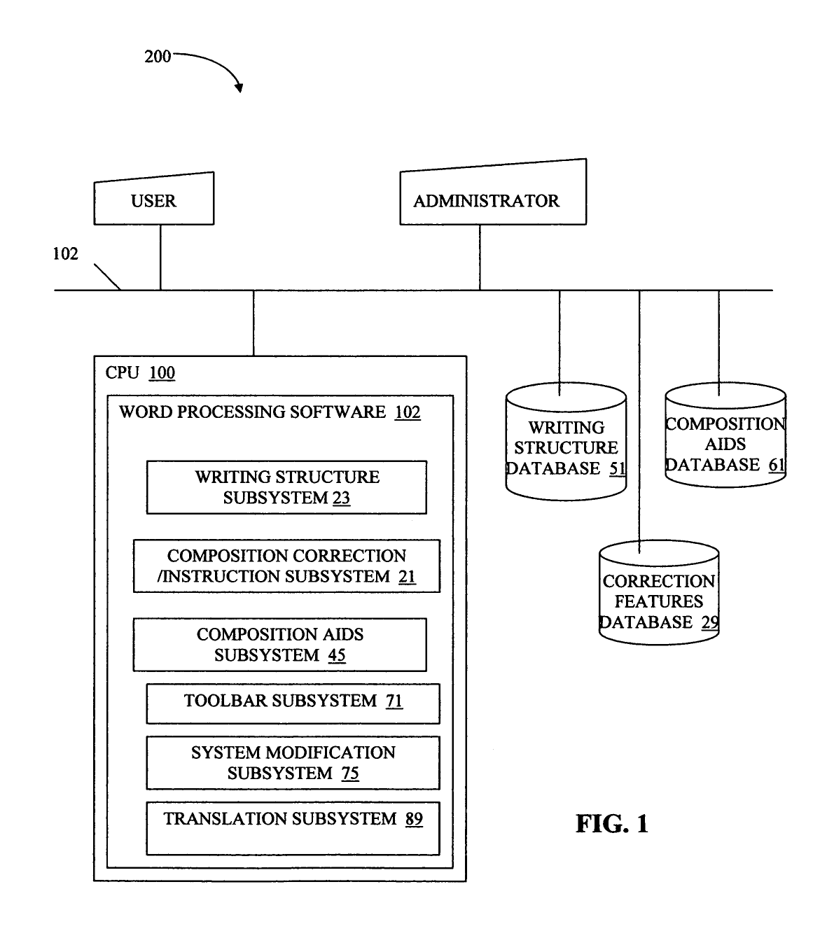

Referring now to FIG. 1, system 200 of the illustrative embodiment of the present invention includes an environment in which word processing software 102, executing on CPU 100, which can be, for example, a personal computer (PC), is in communication with a user or an administrator, either of whom may be accessing CPU 100 through network 102, or may be directly accessing CPU 100, for example, through a terminal interface. CPU 100 may be any type of electronic processor, and may be in communication with supporting databases through network 102 or through any other database access method, including a direct peripheral interface. Supporting databases can include writing structure database 51, composition aids database 61, and correction features database 29. The information that these databases contain can be combined in any way and remain within the spirit of the present invention. In particular, the data are conceptually segregated herein for discussion purposes only. There is no need for actual physical or logical segregation of the data. System 200 may, for example, execute within conventional word processing software 102, can take advantage and build on the capabilities provided by conventional word processing software such as, for example, Word Perfect® or Microsoft Word®, or it may operate stand-alone. System 200 may include such subsystems as writing structure subsystem 23, composition correction/instruction subsystem 21, composition aids subsystem 45, toolbar subsystem 71, system modification subsystem 75, and translation subsystem 89, each of which is described herein. System 200 may include other subsystems and may interface with other systems not shown in FIG. 1.

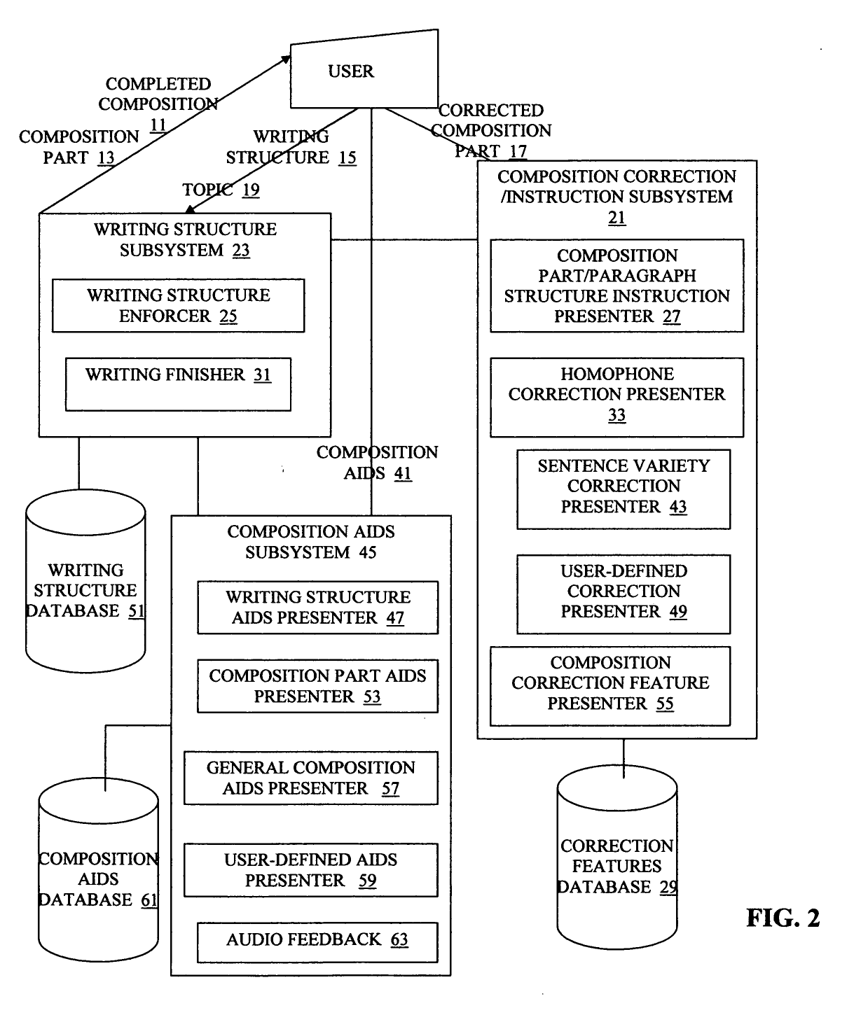

Referring now to FIG. 2, the system of the present invention includes a writing structure subsystem 23, a composition correction/instruction subsystem 21, and a composition aid subsystem 45. Writing structure enforcer 25 insures that the user follows a prescribed writing outline that writing structure enforcer 25 accesses from writing structure database 51. In the illustrative embodiment, writing structure enforcer 25 can present the user with possible topics 19 to choose from, accessed, for example, from writing structure database 51, and the user can create a topic sentence that is the user's opinion about topic 19. While the user is entering the topic sentence and each succeeding sentence, composition aids subsystem 45 could, for example, prompt the user with questions that could help the user to continue the thought of the completed sentence, and composition correction/instruction subsystem 21 could help the user by presenting corrective features associated with writing structure 15 and associated with any composition part 13 that the user enters. For beginning users, for example, an essay-type selected writing structure 15 could require that the topic sentence include the reasons, for example three, that support the opinion expressed in the topic sentence. If, for example, the user is more advanced, another writing structure 15 could require that the reasons be presented in separated sentences. After composition part 13 that has presented topic 19 is complete, composition part/paragraph structure instruction presenter 27 could guide the user according to the information provided by writing structure enforcer 25. For example, composition part/paragraph structure instruction presenter 27 could require, depending on the specific selected writing structure 15, that the user-chosen reasons be supported in the paragraphs that follow the topic paragraph.

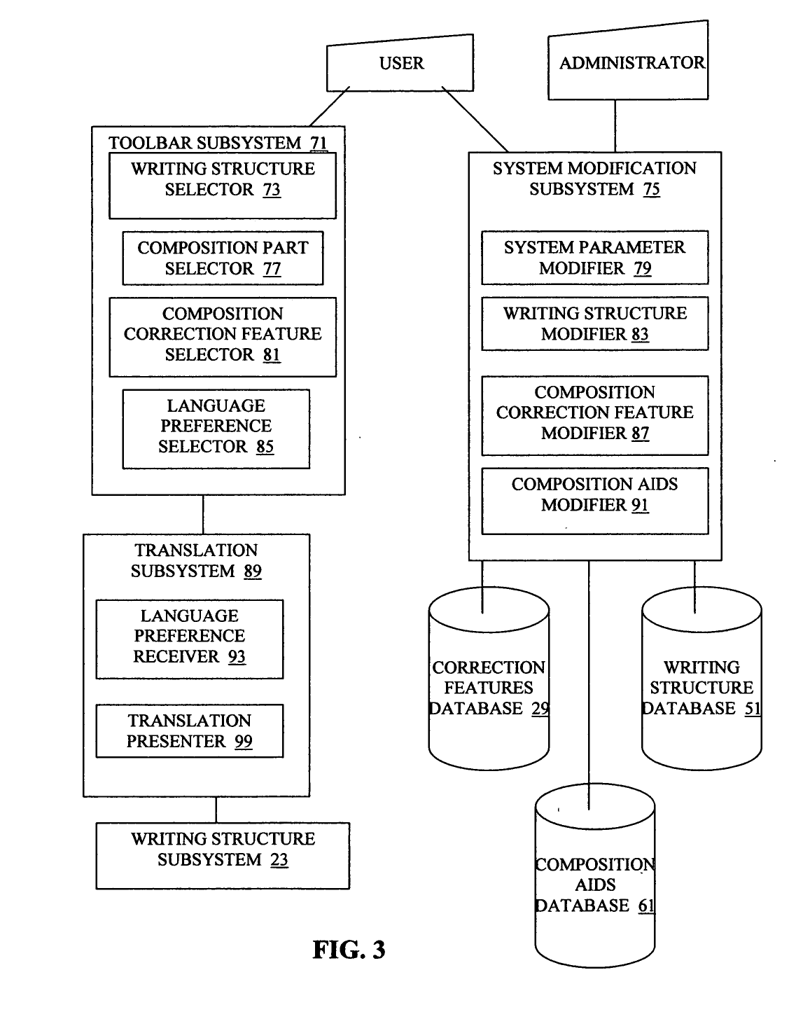

Continuing to refer to FIG. 2, composition part/paragraph structure instruction presenter 27 could require, for example, that the user begin each reason paragraph with a transitional word/phrase. In this case, writing structure aids presenter 47 could present examples of transitional words to the user, a selection of which could be available from composition aids database 61, which can be modified to add additional transition words as described with reference to FIG. 3. Further, according to the structure required by writing structure enforcer 25, composition part/paragraph structure instruction presenter 27 could require, for example, that the user provide as many reasons and examples as are introduced in the topic paragraph as composition parts 13. When the user completes all the reason paragraphs, composition part/paragraph structure instruction presenter 27 could require, for example, a transitional word or phrase followed by a composition part 13 that could become the final paragraph of the essay, in which topic 19 is restated and the user's opinion is reinforced. When the user signals that the composition is complete, writing finisher 31 can present completed composition 11 to the user and, optionally, can save completed composition 11 for later access.

Continuing to further refer to FIG. 2, while the user is preparing the composition, composition aids subsystem 45 can present assistance to the user in the form of structural assistance, individual composition part 13 assistance, general composition aids, user-defined aids, and audio feedback, from composition aids database 61, which could be pre-stored by the system or dynamically selected for the particular situation. If the user desires, translation subsystem 89 (FIG. 3), more fully described with respect to FIG. 3, can translate the composition or any part of it into a user-selected language. Composition correction/instruction subsystem 21 can provide corrective assistance to the user that can be associated with the selected writing structure 15, and the particular composition part 13 that the user is entering. In particular, composition correction/instruction subsystem 21 detects and highlights homophones (through homophone correction presenter 33), sentence variety (through sentence variety correction presenter 43, composition part/paragraph structures (through composition part/paragraph structure instruction presenter 27), and user-defined corrections (through user-defined correction presenter 49). Composition correction feature presenter 55 manages user-friendly placement of composition corrective devices, and presents possible composition corrective features to the user for inspection.

Referring now to FIG. 3, language preference receiver 93 accepts a preferred language from the user and prepares a translation of the composition. Translation presenter 99 provides the translation to the user, for example in text form or, if requested, through audio feedback 63 (FIG. 1) in audio form. System modification subsystem 75 can allow an administrator or the user to tailor the system of the present invention to the particular needs of the user group. For example, writing structure modifier 83 can assist the user or administrator in enlarging the set of writing structures 15 (FIG. 2) available for selection, or can assist in the modification of a certain writing structure 15 to include a different, larger, or smaller set of composition parts 13 (FIG. 2). Composition correction feature modifier 87 can assist the user or administrator in enlarging, decreasing, or updating the possible correction features, such as homophones, that the system makes available to the user during composition preparation. Composition aids modifier 91 can assist the user or administrator in enlarging, decreasing, or updating the possible tips and aids available to the user during composition preparation. An administrator may manipulate system parameters through system parameter modifier 79. Updated information may be stored in the databases that are accessible by the system during composition construction such as, for example, correction features database 29, writing structure database 51, and composition aids database 61.

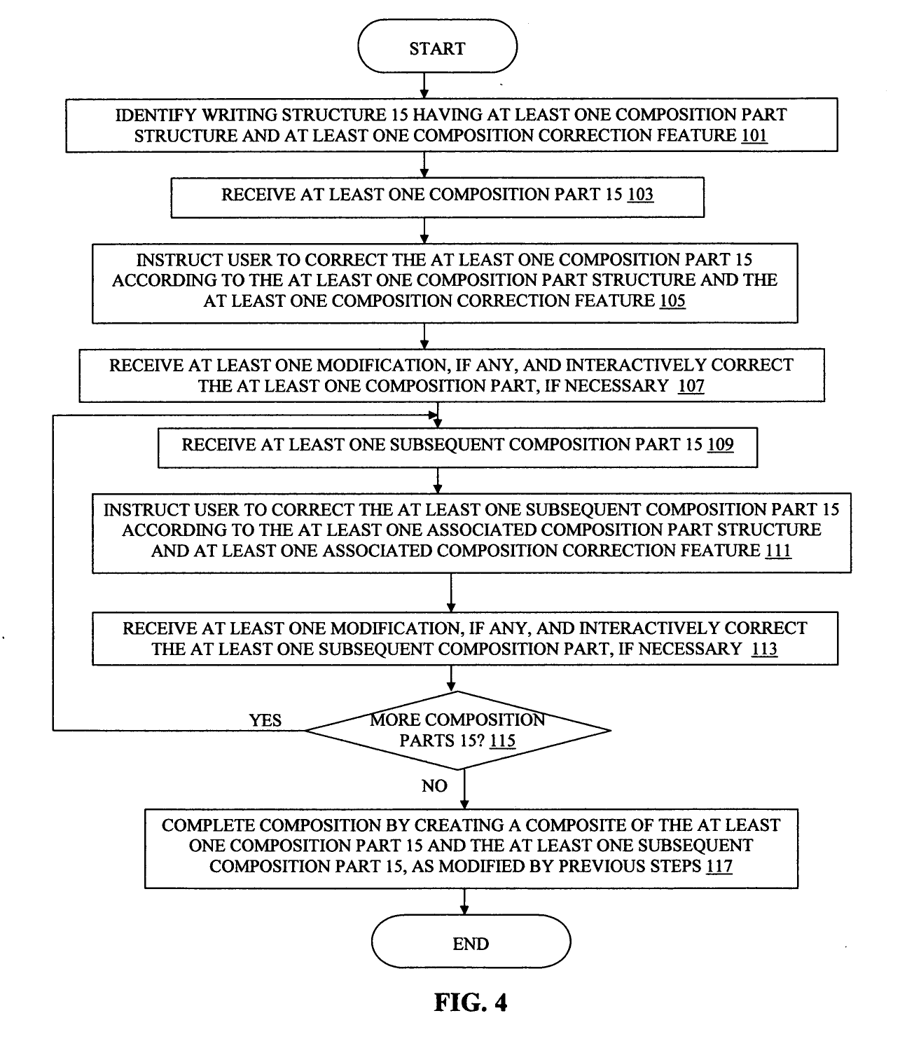

Referring now to FIG. 4, a flowchart of the method of the present invention includes the steps of identifying a writing structure (method step 101) that has at least one composition part structure and at least one composition correction feature, and receiving at least one composition part 13 (method step 103). The method can further include the steps of instructing the user to correct the at least one composition part 13 according to the at least one composition part structure and the at least one composition correction feature (method step 105), receiving at least one modification, if any, and interactively correcting the at least one composition part 13 according to the at least one modification, if necessary (method step 107). As the user proceeds through composition preparation, the method can further include the steps of receiving at least one subsequent composition part 13, if any (method step 109) and instructing the user to correct the at least one subsequent composition part 13 according to the at least one associated composition part structure and at least one associated composition correction feature (method step 111). The method can further includes the steps of receiving at least one modification, if any, and interactively correcting the at least one subsequent composition part 13, if necessary (method step 113). If there are more composition parts 13 (decision step 115), the method repeats method steps 109, 111, and 113. If there are no more composition parts 13 (decision step 115), the method further includes the step of completing the composition by creating a composite of the at least one composition part 13 and the at least one subsequent composition part 13, as modified by previous steps (method step 117).

Optionally, the method can include the steps of translating the composition and/or providing the composition to the user through audio playback. Further, the method can include the steps of selecting the composition correction features from a group that includes homophone identification, verb tense verification, sentence variety verification, and voice verification.

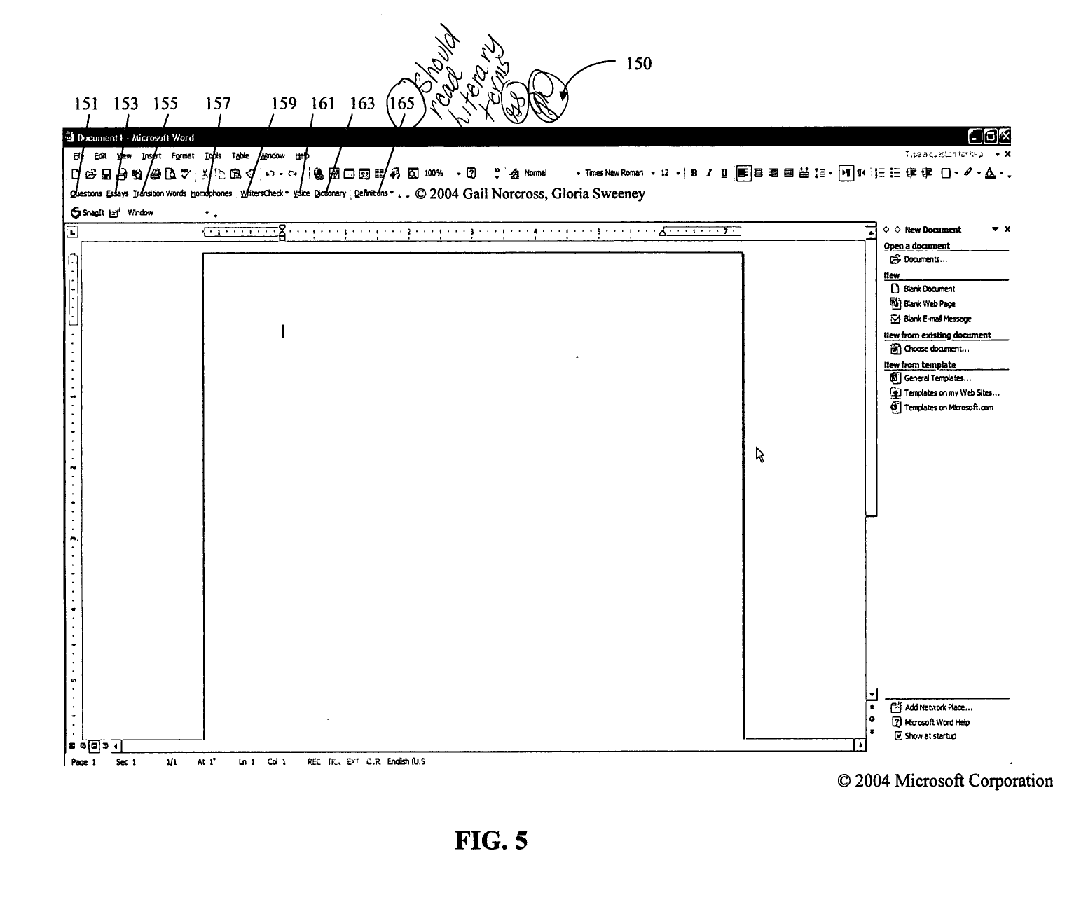

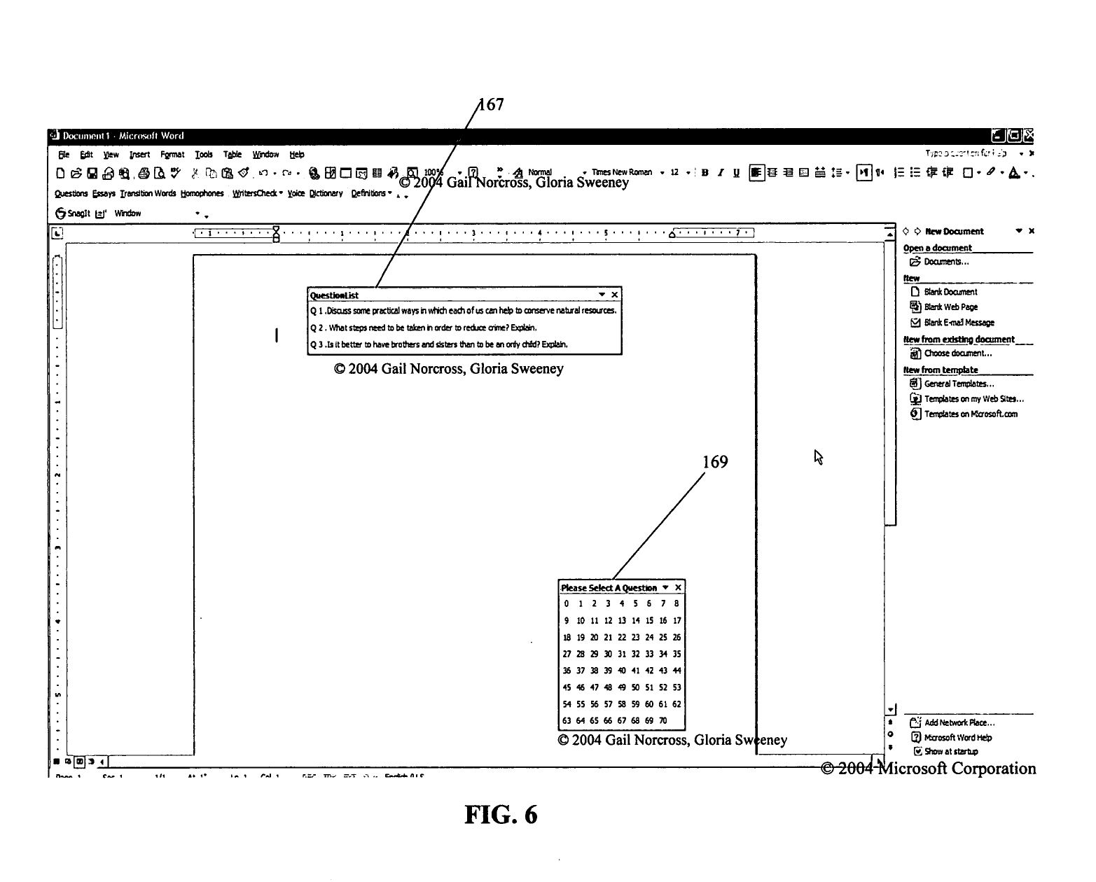

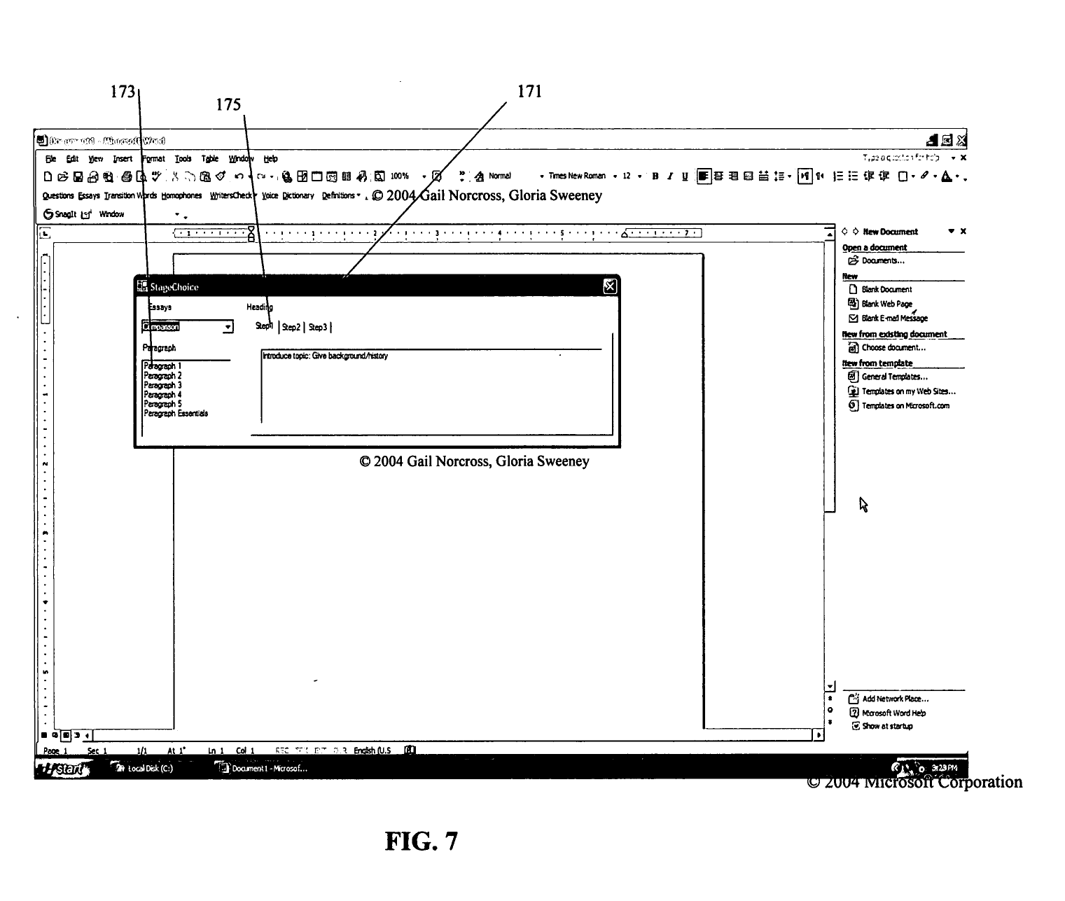

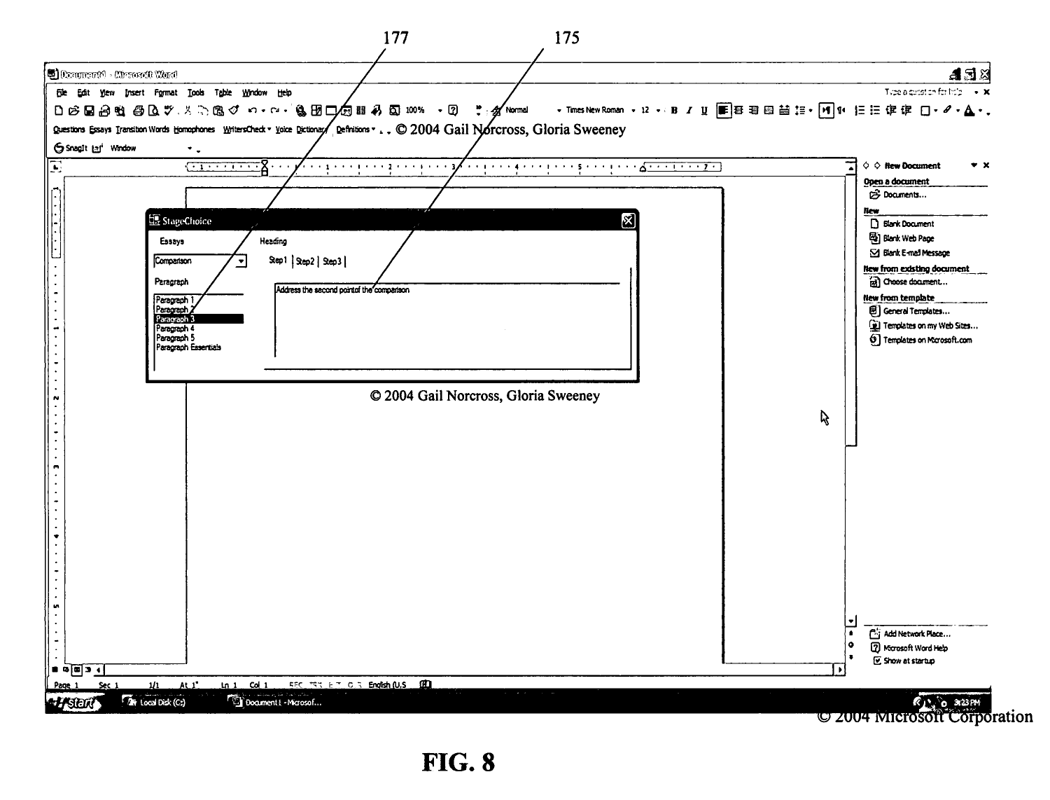

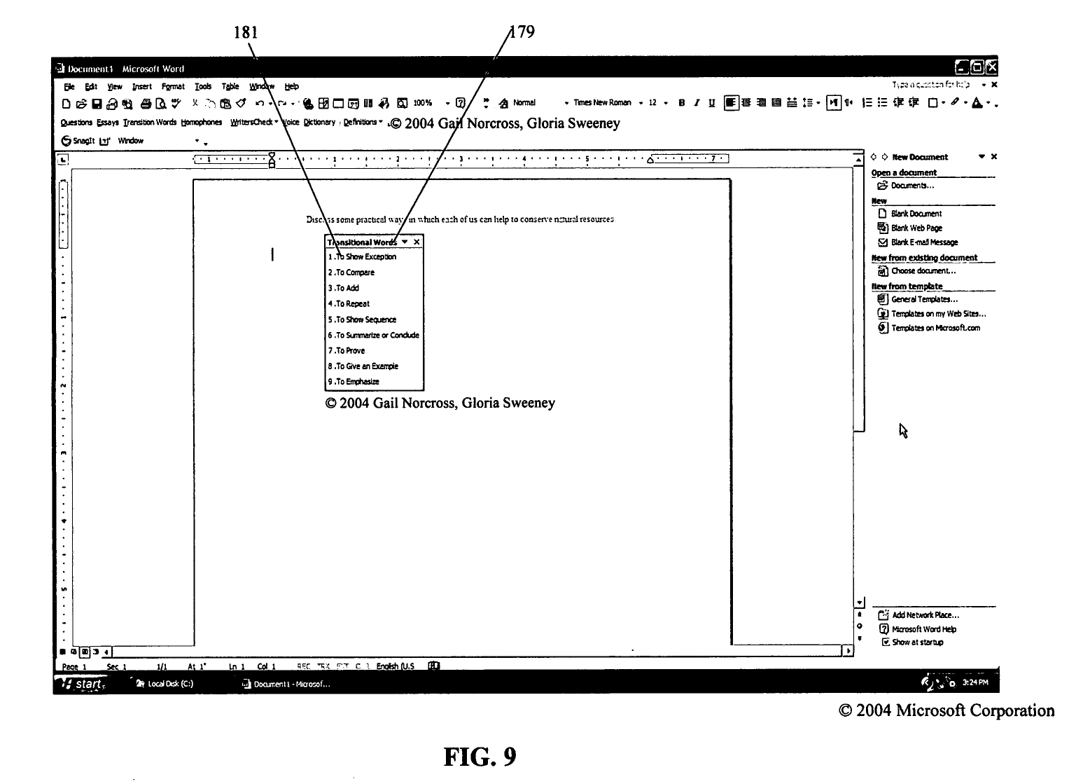

Referring now to FIGS. 2, and 5-9, in the illustrative embodiment, writing structure subsystem 23 (FIG. 2) accepts selected writing structure 15 (FIG. 2), such as, for example, a five-paragraph essay about a topic 19 (FIG. 2). In the system of the present invention, writing structure 15 could be a member of a set of writing structures which could be interrelated such that they build on each other and present the user with graduated levels of writing difficulty. In one implementation of the illustrative embodiment of the present invention is contained a set of system- or user-supplied essay questions 167 (FIG. 6) from which the user can choose by, for example, essay number 169 (FIG. 6), to write an essay. In this implementation, the user can optionally select a writing “stage” from a drop-down toolbar, which indicates the ability level of the user with respect to essay-writing. Further, the user can work on writing a paragraph 173 (FIG. 7) that is part of the essay. Dialogue box 171 (FIG. 7) enables initiation of the execution of the steps 175 (FIG. 7) required to write the paragraphs 177 (FIG. 8) that are part of the essay, for example, underlining the title, indenting the topic/opinion sentence, receiving the reasons and placing them appropriately in the paragraph, indenting for a new paragraph for each reason, receiving and positioning a transitional word, the reason, and the illustrative example, indenting the final paragraph, and accepting a topic summary and a restatement of the opinion. Concise paragraph explanations 175 (FIG. 8) guide the user as to the expected contents of the paragraph according to the selected writing structure 15 (FIG. 2). To assist the user in reviewing spellings beyond the normal capabilities provided by a conventional word processor, the system may contain dictionary 163 (FIG. 5). The system may provide transitional words 179 (FIG. 5) grouped by categories 181 (FIG. 5) so that the user can select a category and then a word within the transitional words category. In the illustrative embodiment of the present invention, homophones may be highlighted when the user clicks on “homophones” 157 (FIG. 5). The user may select any highlighted homophone and the definitions and spellings for the highlighted homophone appear. Upon reading the definitions and spellings, the user may decide to select a different homophone to replace the original homophone.

In an alternative embodiment, verb tense may be color-coded; for example, present tense may be coded green, past tense may be coded red, and future tense may be coded blue. To change a verb tense, for example, the user may select any verb, a dialogue box may appear with verbs color-coded according to tense, and the user may select a verb. In another alternative embodiment, sentence variety may be reviewed. In this embodiment, the system may highlight, upon user request, sentences according to the part of speech they begin with. The user may then be able modify the composition to include the desired amount of sentence variety. In a yet further embodiment, the user may review the way the composition reads through an audio playback of the composition starting with the word in which the user places the cursor. The user can also translate the composition into a preferred language, and listen to a playback of the translation.

Although the invention has been described with respect to an illustrative embodiment, it should be realized this invention is also capable of a wide variety of further and other embodiments within the spirit and scope of the appended claims.

What is claimed is:

1. A method for composition instruction comprising the steps of:
(a) identifying a writing structure, the writing structure being associated with at least one composition correction feature, the writing structure having at least one composition part structure;
(b) receiving at least one composition part of a composition;
(c) instructing a user to interactively correct the at least one composition part according to the at least one composition part structure;
(d) instructing the user to interactively correct the at least one composition part according to the at least one composition correction feature;
(e) receiving at least one modification, if any, and interactively correcting the at least one composition part, if necessary;
(f) receiving at least one subsequent composition part, if any;
(g) instructing the user to interactively correct the at least one subsequent composition part according to the at least one composition part structure;
(h) instructing the user to interactively correct the at least one subsequent composition part according to the at least one composition correction feature;
(i) receiving at least one modification, if any, and interactively correcting the at least one subsequent composition part, if necessary; and
(j) repeating steps (g) through (i) until the composition is complete, the composition being a composite of the at least one composition part, if any, and the at least one subsequent composition part, if any, as modified in steps (e) and (i).

2. The method as defined in claim 1 further comprising the steps of:
receiving and recording modifications to at least one system parameter selected from a group including the writing structure, the at least one composition part structure, and the at least one composition correction feature; and
displaying a toolbar allowing the user to select from a toolbar list including the writing structure, the at least one composition part, and the at least one composition correction feature.

3. The method as defined in claim 1 further comprising the step of
supplying at least one composition aid during said steps (a) through (i), the at least one composition aid being associated with any member of the group that includes the writing structure, the at least one composition part structure, and the at least one composition correction feature.

4. The method as defined in claim 3 further comprising the step of selecting the at least one composition aid from a group including composition type, writing structure, paragraph contents, general paragraph rules, transitional words, homophones, sentence variety keys, figurative language list, figurative language definitions, dictionaries, voice playback, overall composition check, translation, and user-defined composition aids.

5. The method as defined in claim 3 further comprising the steps of:
receiving and recording modifications to at least one system parameter selected from a group including the writing structure, the at least one composition part structure, the at least one composition correction feature, and the at least one composition aid, the at least one composition aid including composition questions, writing structure, transition word list, voice types, sentence variety parameters, figurative language list, figurative language definitions, translation languages, and general paragraph rules; and
displaying a toolbar allowing the user to select from a toolbar list including the writing structure, the at least one composition part, the at least one composition correction feature, and the at least one composition aid.

6. The method as defined in claim 1 further comprising the step of selecting the writing structure from a group including creative composition, factual composition, academic thesis, historical composition, and user-defined structures.

7. The method as defined in claim 1 further comprising the step of selecting the at least one composition correction feature from a group including writing structure, paragraph structure, homophone identification, sentence variation, verb tense, composition voice, and user-defined correction features.

8. The method as defined in claim 1 further comprising the step of:
providing an audio review of the composition.

9. The method as defined in claim 1 further comprising the steps of:
identifying a preferred language; and
translating the composition into the preferred language.

10. The method as defined in claim 9 further comprising the step of:
providing an audio review of the translated composition.

11. A system for educating a writer comprising:
a writing structure subsystem capable of enforcing a writing structure while receiving at least one composition part;
a composition correction/instruction subsystem capable of instructing a user to interactively correct said at least one composition part according to at least one composition correction feature, said composition correction/instruction subsystem capable of receiving from the user at least one interactively corrected composition part, if any,
wherein said writing structure subsystem forms a completed composition from said at least one composition part and said at least one interactively corrected composition part, if any.

12. The system as defined in claim 11 further comprising:
a system modification subsystem capable of receiving modifications to and modifying at least one system parameter, said at least one system parameter including said writing structure and said at least one composition correction feature; and
a toolbar subsystem capable of allowing the user to select the writing structure, the at least one composition part, and the at least one composition correction feature.

13. The system as defined in claim 11 further comprising:
a composition aids subsystem capable of interactively providing at least one composition aid while the composition is being received, said at least one composition aid being associated with any member of the group that includes the writing structure, the at least one composition part structure, and the at least one composition correction feature.

14. The system as defined in claim 13 wherein said at least one composition aid is selected from a group that includes composition type, writing structure, paragraph contents, general paragraph rules, transitional words, homophones, sentence variety keys, figurative language list, figurative language definitions, dictionaries, voice playback, overall composition check, translation, and user-defined composition aids.

15. The system as defined in claim 13 further comprising:
a system modification subsystem capable of receiving modifications to and modifying said at least one system parameter, said at least one system parameter including composition questions, writing structure, transition word list, voice types, sentence variety parameters, figurative language list, figurative language definitions, translation languages, and general paragraph rules; and
a display subsystem capable of allowing the user to select the writing structure, the at least one composition part, the at least one composition correction feature, and the at least one composition aid.

16. The system as defined in claim 13 wherein said composition aids subsystem comprises an audio review of the composition.

17. The system as defined in claim 13 wherein said composition aids subsystem comprises a translation subsystem, said translation subsystem capable of translating the composition into a preferred language.

18. The system as defined in claim 13 wherein said composition aids subsystem comprises a translation subsystem, said translation subsystem capable of translating the composition into a preferred language, said composition aids subsystem capable of providing an audio review of said composition in said preferred language.

19. The system as defined in claim 11 wherein said writing structure is selected from a group including creative composition, factual composition, academic thesis, historical composition, and user-defined structures.

20. The system as defined in claim 11 wherein said at least one composition correction feature from a group including writing structure, paragraph structure, homophone identification, sentence variation, verb tense, composition voice, and user-defined correction features.

21. A node for carrying out the method according to claim 1.

22. A communications network comprising at least one node according to claim 1.

23. A computer data signal embodied in electromagnetic signals traveling over a computer network carrying information capable of causing a computer system in the network to practice the method of claim 1.

24. A computer readable medium having instructions embodied therein for the practice of the method of claim 1.
